(19) United States
(12) Patent Application Publication
(10) Pub. No.: US 2011/0085216 A1
(43) Pub. Date: Apr. 14, 2011

(54) Scanner, image forming apparatus, and image compensating method of scanner

(75) Inventor: Sang-hoon Noh, Seoul (KR)

(73) Assignee: SAMSUNG ELECTRONICS CO., LTD., Suwon-si (KR)

(21) Appl. No.: 12/656,772

(22) Filed: Feb. 16, 2010

(30) Foreign Application Priority Data
Oct. 8, 2009 (KR) 10-2009-0095423

(51) Int. Cl. H04N 1/04

(52) U.S. Cl. 358/498; 358/474

(57) ABSTRACT

The scanner includes: a transporting unit which transports a manuscript and passes the manuscript through a preset image reading position; an image reading unit which outputs a scan image obtained by sequentially line-scanning the manuscript passing through the image reading position; at least two actuators which are isolated from each other in a horizontal direction with respect to a manuscript transport direction, each having a first end portion which is movable with interference with the manuscript being transported and a second end portion which is placed on a scanning line scanned by the image reading unit and is movable in interlock with the first end portion; and an image processing unit which reads images for skew detection which are formed in the scan image by the movement of the second end portions.

### CROSS-REFERENCE TO RELATED APPLICATIONS

This application claims priority from Korean Patent Application No. 10-2009-0095423, filed on Oct. 8, 2009 in the Korean Intellectual Property Office, the disclosure of which is incorporated herein by reference.

### BACKGROUND

1. Field

Methods and devices consistent with the present embodiments relate to a scanner which scans an object such as a manuscript or the like, an image forming apparatus which forms a scanned image on a printing medium as a visible image, and an image compensating method of the scanner, and more particularly, to a scanner and an image forming apparatus with a structure which is capable of compensating an image of a scanned manuscript, and an image compensating method of the scanner.

2. Description of the Related Art

A scanner is an apparatus which scans a variety of objects with a scanning sensor to output a digital image of a corresponding object and may be implemented alone or in a composite structure including a copier, a multifunction printer (MFP) and so on.

In general, there are two methods for scanning an object: one for scanning a fixed object while moving a scanning sensor; and another for scanning an object while passing the object through a fixed scanning sensor. The latter scanning method may be applied when an object is a standardized manuscript.

When a manuscript is scanned while being moved, the manuscript may be obliquely moved without a leading end of the manuscript aligned in the course of movement, which may result in a skew effect that an image of the scanned manuscript appears in a slightly-oblique fashion. For the purpose of preventing such a skew effect, there have been conventionally proposed a method of moving a manuscript after aligning it, a method of detecting a manuscript edge in an image of a scanned manuscript and aligning the detected edge in parallel with a reference line, etc.

However, these conventional methods have the following problems. The former method requires additional physical structures, which may result in complexity in its structure, difficulty in miniaturization, and increase in production costs. In addition, this method may cause a performance deviation between apparatuses due to a structural tolerance. The latter method may inadequately definitely detect the edge of the manuscript because a background color of the manuscript is often white.

### SUMMARY

Accordingly, it is an aspect to provide a scanner and an image forming apparatus which are capable of calculating a skew angle with a simple configuration and compensating a scan image based on the skew angle in order to prevent a skew effect which may occur when a manuscript is moved and scanned, and an image compensating method of the scanner.

Additional aspects will be set forth in part in the description which follows and, in part, will be apparent from the description, or may be learned by practice of the present embodiments.

The foregoing and/or other aspects can be achieved by providing a scanner including: a transporting unit which transports a manuscript and passes the manuscript through a preset image reading position; an image reading unit which outputs a scan image obtained by sequentially line-scanning the manuscript passing through the image reading position; at least two actuators which are isolated from each other in a horizontal direction with respect to a manuscript transport direction, each having a first end portion which is movable with interference with the manuscript being transported and a second end portion which is placed on a scanning line scanned by the image reading unit and is movable in interlock with the first end portion; and an image processing unit which reads images for skew detection which are formed in the scan image by the movement of the second end portions.

The image processing unit may calculate a skew angle of the scan image from position information on the images for skew detection and compensates the scan image based on the calculated skew angle.

The image processing unit may calculate an angle between a straight line connecting leading ends of the images for skew detection formed by the second end portions and the scanning line, as the skew angle.

The scanner may further include a plate which has a plurality of openings opened/closed by the second end portion and extends to face the image reading unit with a manuscript transport path interposed between the plate and the image reading unit.

The actuators may be provided such that the second end portions closes the openings if the first end portions do not interfere with the manuscript and the second end portions open the openings when the first end portions are rotated with interference with the manuscript.

The first end portions may be rotated around a shaft with the interference with the manuscript and the second end portions are rotated in interlock with the first end portions.

A predetermined pattern may be formed on one side of the second end portion facing the image reading unit, and the image processing unit may read the images for skew detection based on a variation of the patterned image in the scan image.

The plate may include a transparent member formed in the openings.

The first end portions may be formed at an input stage of the manuscript at the image reading position.

The foregoing and/or other aspects can be achieved by providing an image forming apparatus including: a scanner which scans a manuscript; and a printer which forms an image of the manuscript scanned by the scanner on a printing medium, wherein the scanner includes: a transporting unit which transports the manuscript and passes the manuscript through a preset image reading position; an image reading unit which outputs a scan image obtained by sequentially line-scanning the manuscript passing through the image reading position; at least two actuators which are isolated from each other in a horizontal direction with respect to a manuscript transport direction, each having a first end portion which is movable with interference with the manuscript being transported and a second end portion which is placed on a scanning line scanned by the image reading unit and is movable in interlock with the first end portion; and an image processing unit which reads images for skew detection which are formed in the scan image by the movement of the second end portions.

The image processing unit may calculate a skew angle of the scan image from position information on the images for skew detection, compensate the scan image based on the calculated skew angle, and output the compensated scan image to the printer.

The foregoing and/or other aspects can be achieved by providing an image compensating method of a scanner including an image reading unit which scans a manuscript passing through a preset image reading position; and at least two actuators which are isolated from each other in a horizontal direction with respect to a manuscript transport direction, each having a first end portion which is movable with interference with the manuscript being transported and a second end portion which is placed on a scanning line scanned by the image reading unit and is movable in interlock with the first end portion, including: outputting a scan image obtained by sequentially line-scanning the manuscript passing through the image reading position; and reading images for skew detection which are formed in the scan image by the movement of the second end portions.

The reading images for skew detection may include: calculating a skew angle of the scan image from position information on the images for skew detection; and compensating the scan image based on the calculated skew angle.

The calculating a skew angle of the scan image may include calculating an angle between a straight line connecting leading ends of the images for skew detection formed by the second end portions and the scanning line, as the skew angle.

A predetermined pattern may be formed on one side of the second end portion facing the image reading unit, and the reading images for skew detection may include reading the images for skew detection based on a variation of the patterned image in the scan image.

The first end portions may be formed at an input stage of the manuscript at the image reading position.

According to an aspect, if a skew effect occurs when a manuscript is transported and scanned, it is possible to simply calculate a skew angle using two actuators which are isolated from each other and easily and accurately compensate a scan image. Thus, a final scan image of high quality can be ensured.

In addition, since there is no need to employ a complicated separate configuration for alignment of transported manuscripts and particularly a configuration for driving, such as a motor, a structure is simple and production costs can be reduced. In addition, the skew angle can be calculated even when it is difficult to detect an edge of the manuscript in the scan image.

In addition, when the predetermined pattern is formed on one side of the second end portion, the images for skew detection are read from the variation of the patterned image, faster than a case where the second end portions opens the openings.

In addition, the transparent member formed in the openings prevents the manuscript being transported from being hindered by being caught on the openings.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a side sectional view showing an image forming apparatus according to an exemplary embodiment;

FIG. 2 is a block diagram showing an image processing configuration of the image forming apparatus of FIG. 1;

FIG. 3 is a main part perspective view of a plate and actuators in the image forming apparatus of FIG. 1;

FIG. 4 is a main part perspective view showing a state where a second end portion of a first actuator closes a first opening in the image forming apparatus of FIG. 3;

FIGS. 5A and 5B are exemplary views showing a relationship between a rotation position of the first actuator and a scanning operation of an image reading unit in the image forming apparatus of FIG. 3;

FIG. 6 is an exemplary view of a scan image primarily scanned by the image reading unit in the image forming apparatus of FIG. 3;

FIG. 7 is an exemplary view showing a method in which an image processing unit compensates a scan image based on a skew angle in the image forming apparatus of FIG. 3;

FIG. 8 is a control flow chart showing a process of compensating a scan image in the image forming apparatus of FIG. 1; and

FIG. 9 is a perspective view showing an actuator according to an embodiment different from the embodiment of the image forming apparatus.

### DETAILED DESCRIPTION

Reference will now be made in detail to the embodiments, examples of which are illustrated in the accompanying drawings, so that those in the art can easily practice the present embodiments. The present invention is not limited to exemplary embodiment disclosed herein but may be implemented in different forms.

In the following embodiments, for the purpose of clarity, the same components are denoted by the same reference numerals throughout the drawings, and explanation thereof will be representatively given in a first embodiment but will be omitted in other embodiments.

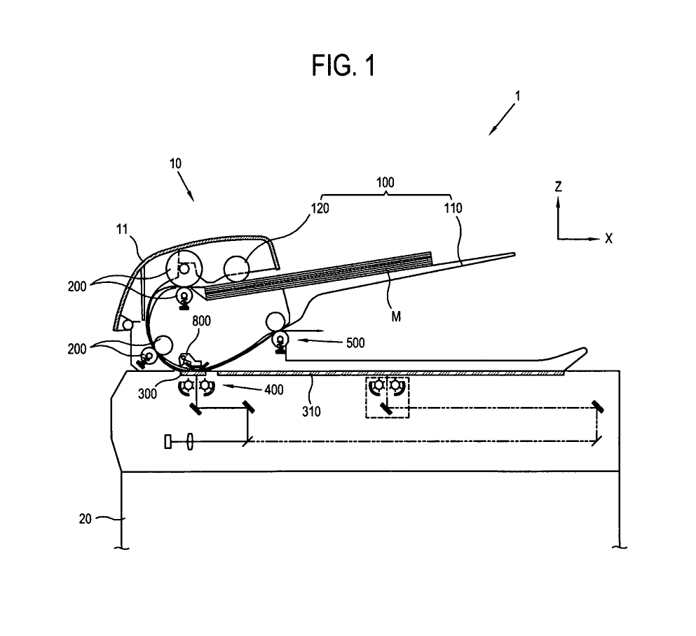

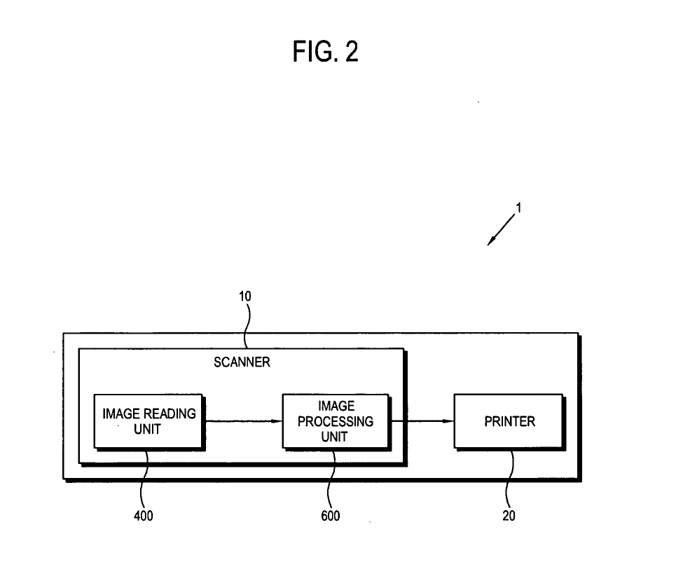

FIG. 1 is a side sectional view showing an image forming apparatus 1 according to an exemplary embodiment, and FIG. 2 is a block diagram showing an image processing configuration of the image forming apparatus 1.

The image forming apparatus 1 according to this embodiment may be implemented with a copier or a multifunction printer (MFP) including a scanner 10 and a printer 20 only by way of example but the spirit of the invention is not limited thereto. The spirit of the invention can be applied to the scanner 10 alone to which the following embodiment can be applied, and therefore, explanation of which will be omitted.

In addition, it is noted that the following embodiment illustrates only a configuration having direct relation to the embodiment for the sake of clarity of the spirit of the invention and configurations not illustrated in this embodiment are not excluded from the implementation of the scanner 10 or the image forming apparatus 1 to which the spirit of the invention is applied.

As shown in FIGS. 1 and 2, the image forming apparatus 1 according to this embodiment includes a scanner 10 which scans a manuscript M to form and outputs a scan image and a printer 20 which forms the scan image output from the scanner 10 on a printing medium as a visible image.

The scanner 10 may be implemented in a hybrid manner. That is, the scanner 10 may scan the manuscript M either with it fixed or with it being moved. This embodiment focuses on a configuration of the scanner 10 corresponding to the latter case.

The printer 20 prints an image output from the scanner 10 or a separate host (not shown) connected thereto on a printing medium using a developer, ink or the like. To this end, the printer 20 may employ any printing methods including electro-photography, inkjet and so on which are known in the art and will be thus omitted for simplicity in this embodiment.

Hereinafter, the configuration of the scanner 10 will be described in more detail.

The scanner 10 includes a housing 11 which makes an external form to accommodate various components of the scanner 10, a manuscript supplying unit 100 which supplies a manuscript M, a manuscript transporting unit 200 which transports the manuscript M, a transparent flat plate 300 disposed near a manuscript (M) transport path along which the manuscript M passes, an image reading unit 400 which scans the manuscript M by irradiating the manuscript M with light passing through the transparent flat plate 300, a manuscript discharging unit 500 which discharges the scanned manuscript M, and an image processing unit 600 which processes and outputs an image of the manuscript M scanned by the image reading unit 400.

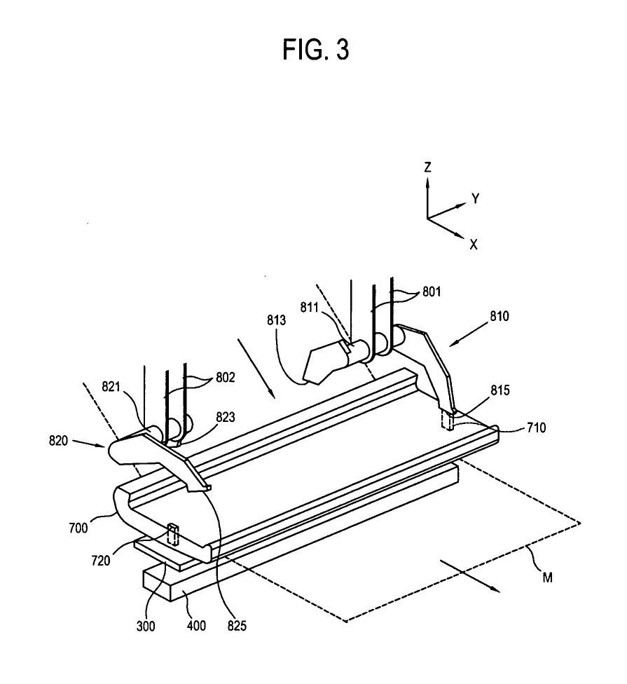

In this embodiment, in addition to the above-mentioned components, as shown in FIG. 3, the scanner 10 further includes a plate 700 placed opposite the transparent flat plate 300 with the manuscript (M) transport path interposed therebetween, and a pair of actuators 810 and 820 placed near the plate 700 and the manuscript (M) transport path.

When a scanning operation starts, the manuscript supplying unit 100 picks up loaded manuscripts M one by one and supplies them to the manuscript transporting unit 200. The manuscript supplying unit 100 includes a tray 110 on which a plurality of manuscripts M is loaded, and a pickup roller 120 which picks up the uppermost one of the plurality of manuscripts M loaded on the tray 110.

The manuscript transporting unit 200 transports and passes the manuscript M picked up by the pickup roller 120 through a preset image reading position. The manuscript transporting unit 200 may include a plurality of pairs of mutually-contacting rollers placed along a predetermined transport path. In this embodiment, for the sake of convenience, the image reading position refers to a position at which a transported manuscript M is to be scanned.

The transparent flat plate 300 is placed at the image reading position below the manuscript (M) transport path. The manuscript M is slidably moved on the transparent flat plate 300, when light emitted from the image reading unit 400 below the transparent flat plate 300 arrives at the manuscript M after passing through the transparent flat plate 300. In other words, the transparent flat plate 300 is interposed between the manuscript (M) transport path and the image reading unit 400 to prevent the manuscript M from approaching the image reading unit 400.

The transparent flat plate 300 extends in a horizontal direction with respect to an X direction which is a direction in which the manuscript M is transported, such that a line scanning operation can be performed in a width direction of the transported manuscript M.

In addition to such a transparent flat plate 300, the scanner 10 further includes a flat-bed type transparent flat plate placed to allow the manuscript M mounted thereon to be scanned by the image reading unit 400 being moved.

The image reading unit 400 generates a scan image of the manuscript M by irradiating the manuscript M passing by the image reading position with light passing through the transparent flat plate 300 and receiving reflected light from the manuscript M. The image reading unit 400 scans the manuscript M line by line in the horizontal direction with respect to the direction in which the manuscript M is transported. That is, the image reading unit 400 sequentially reads horizontal pixel lines, which are in parallel to a predetermined scanning line, from the manuscript M and delivers the read horizontal pixel lines to the image processing unit 600.

The image processing unit 600 primarily generates a scan image by sequentially placing the horizontal pixel lines received from the image reading unit 400 in a read order. The image processing unit 600 determines a manuscript (M) scan image, which is an effective image, from this scan image and processes the determined manuscript (M) scan image according to various preset processes, thereby generating a final scan image. The image processing unit 600 outputs the generated final scan image to the printer 20 or a separate computer (not shown).

However, when the image processing unit 600 primarily generates the scan image in this manner, there may occur a skew effect that the manuscript (M) scan image as the effective image appears inclined at a certain angle with respect to the scanning line.

In case where the manuscript M is a standardized rectangular or square paper such as A4, Letter or the like, it is ideal that the manuscript M should be transported with an edge of its lead end parallel to the scanning line by the image reading unit 400. However, while the manuscript M is being transported by the manuscript transporting unit 200, the edge of the leading end of the manuscript M may be inclined at a certain angle, which is called “skew angle,” with respect to the scanning line.

In primarily generating the scan image, the image processing unit 600 may calculate the skew angle and compensate a skew state of the manuscript (M) scan image based on the calculated skew angle. In this embodiment, the skew angle may be easily calculated with a simple configuration.

Hereinafter, a configuration for calculating the skew angle according to this embodiment will be described with respect to FIG. 3. FIG. 3 is a main part perspective view of the plate 700 and the actuators 810 and 820 according to this embodiment.

As shown in FIG. 3, assuming that the manuscript M is moved in the X direction, the plate 700, the transparent flat plate 300 and the image reading unit 400 are layered in a vertical Z direction. The plate 700, the transparent flat plate 300 and the image reading unit 400 extend along a Y direction perpendicular to the X and Z directions. That is, an axial line of the Y direction is parallel to the scanning line.

The plate 700 faces the transparent flat plate 300 with the manuscript (M) transport path interposed therebetween. The plate 700 prevents the manuscript M from being distortedly scanned by pressing the manuscript M passing through the image reading position to be closely adhered to the transparent flat plate 300. The side of the plate 700 facing the image reading unit 400 is formed in white to improve light reflectivity.

The plate 700 has two separated openings 710 and 720, i.e., a first opening 710 formed in the left side of the plate 700 along the manuscript (M) transport direction and a second opening 710 formed in the right side of the plate 700. Positions of the openings 710 and 720 and a distance therebetween are not particularly limited, but they are preferably located within a range in which the manuscript M can be scanned by the image reading unit 400 on the axial line of the Y direction.

The openings 710 and 720 may be formed as holes or provided with a transparent member to prevent the manuscript M from being caught on the openings 710 and 720.

The actuators 810 and 820 may include a first actuator 810 and a second actuator 820 which are formed to be isolated from each other along the horizontal direction with respect to the manuscript (M) transport direction, i.e., along the axial line of the Y direction. Although this embodiment shows only the two actuators 810 and 820, it may employ three or more actuators which should be isolated from each other.

The first actuator 810 includes a first rotation shaft 811 which is rotatably supported by a support frame 801, and first and second end portions 813 and 815 which are respectively coupled to one end portion and the other end portions of the first rotation shaft 811.

The first end portion 813 of the first actuator 810 extends from the image reading position in a direction in which the manuscript M is input and at least a portion of the first end portion 813 is located in a manner to interfere with the manuscript (M) transport path. When the leading end of the manuscript M being transported toward the image reading position contacts the first end portion 813 of the first actuator 810, the first end portion 813 interferes with the manuscript M being transported and is rotated around the first rotation shaft 811. As the tailing end of the manuscript M escapes from the first end portion 813, when the interference of the manuscript M with the first end portion 813 is released, the first end portion 813 returns to its original position.

The second end portion 815 of the first actuator 810 is located on the scanning line and is rotated in interlock with the first end portion 813. The second end portion 815 closes the first opening 710 when the second end portion 815 is mounted on the top surface of the plate 700 under an initial state where the manuscript M is not transported. As the first end portion 813 is rotated by the interference of the manuscript M with the first end portion 813, the second end portion 815 is rotated in a direction to open the first opening 710. When the first end portion 813 returns to its original position as the interference of the manuscript M with the first end portion 813 is released, the second end portion 815 closes the first opening 710.

The second actuator 820 includes a second rotation shaft 821 which is supported by a support frame 802, and first and second end portions 823 and 825, all of which have the same configuration as those of the first actuator 810. That is, the second end portion 825 of the second actuator 825 closes or opens the second opening 720 in a manner similar to the first actuator 810.

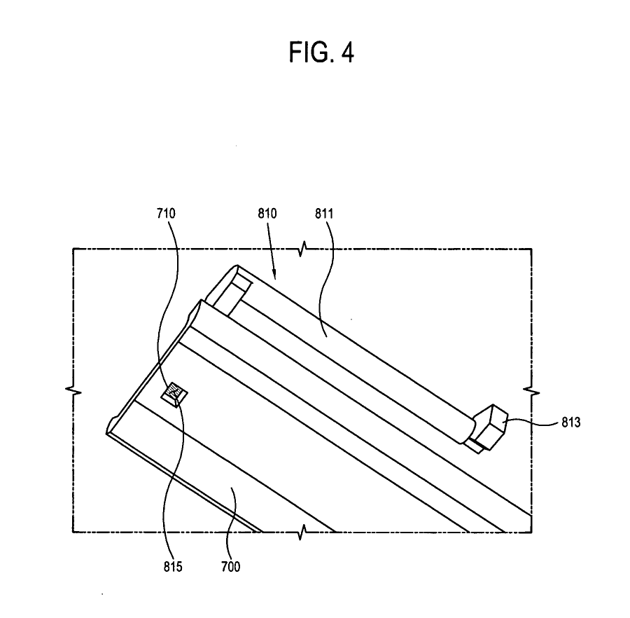

FIG. 4 is a main part perspective view showing a state where the second end portion 815 of the first actuator 810 closes the first opening 710.

As shown in FIG. 4, when the plate 700 is viewed from a direction in which the image reading unit 400 emits light, it can be seen that one side of the second end portion 815 of the first actuator 810 is viewed through the first opening 710. In this embodiment, the one side of the second end portion 815 closing the first opening 710 has the same color, i.e., white, as the side of the plate 700.

In this manner, when the image reading unit 400 scans the manuscript M to generate the scan image under the condition where the first opening 710 is closed, the plate 700 and the first opening 710 will induce a substantially similar contrast ratio in the generated scan image. On the other hand, when the first opening 710 is opened, the plate 700 and the first opening 710 will induce distinct contrast ratios in the generated scan image.

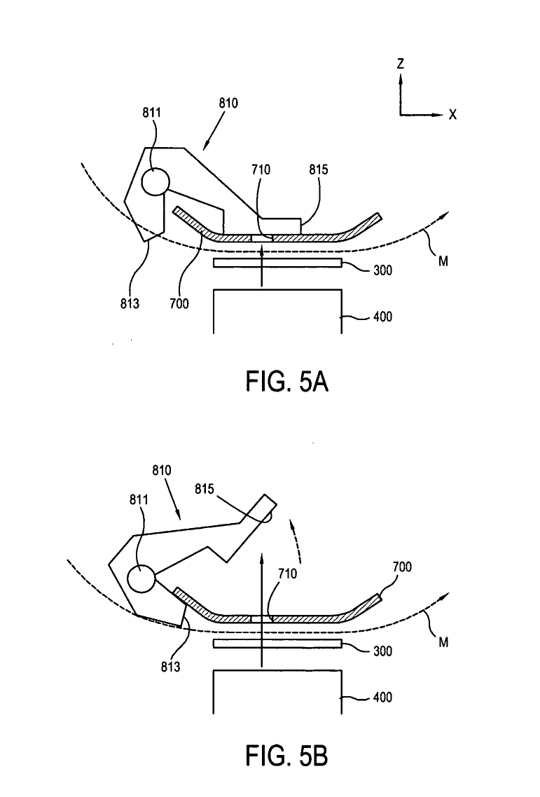

Such a difference depending on the driving of the actuators 810 and 820 will be described in more detail with reference to FIGS. 5A and 5B. FIGS. 5A and 5B are exemplary views showing a relationship between a rotation position of the first actuator 810 and a scanning operation of the image reading unit 400.

FIG. 5A shows an initial state where the manuscript M does not yet approach the image reading position. As shown, the first end portion 813 of the first actuator 810 does not interfere with the manuscript M while the second end portion 815 closes the first opening 710. The light emitted from the image reading unit 400 arrives at the first opening 710 and the plate 700 after passing through the transparent flat plate 300.

In this case, since the first opening 710 is closed by the second end portion 815 of the first actuator 810, the light is reflected by the second end portion 815 and then received in the image reading unit 400.

On the other hand, FIG. 5B shows a state where the manuscript M approaches or passes through the image reading position. In this case, the first end portion 813 of the first actuator 810 is rotated counterclockwise as it interferes with the manuscript M, and the second end portion 815 of the first actuator 810 opens the first opening 710 accordingly.

The light emitted from the image reading unit 400 passes through the first opening 710. In this case, the light may not be received in the image reading unit 400 after passing through the first opening 710 or a distance by which the light travels until the light is received in the image reading unit 400 after passing through the first opening 710 is longer than that in FIG. 5A. In other words, when the first opening 710 is opened, the scan image shows a contrast ratio different from that induced when the first opening 710 is closed.

In this embodiment, since the first and second actuators 810 and 820 are isolated from each other along the scanning line, the first end portion 813 of the first actuator 810 and the first end portion 823 of the second actuator 820 are rotated by the edge of the leading end of the manuscript M. Then, the first opening 710 and the second opening 720 are respectively opened by the second end portion 815 of the first actuator 810 and the second end portion 825 of the second actuator 820 which are respectively rotated in interlock with the rotation of the first end portion 813 of the first actuator 810 and the first end portion 823 of the second actuator 820.

On the other hand, if the leading end of the manuscript M is not parallel to the scanning line, the point of time when the manuscript M interferes with the first end portion 813 of the first actuator 810 is different from the point of time when the manuscript M interferes with the first end portion 823 of the second actuator 820. That is, the timing at which the first opening 710 is opened is different from the timing at which the second opening 720 is opened. In this case, an effective portion of the scan image of the manuscript M appears distorted at a certain angle with respect to the scanning line.

The image processing unit 600 reads two images for skew detection, which are respectively formed by the rotation of the second end portion 815 of the first actuator 810 and the second end portion 825 of the second actuator 820, from the scan image, and calculates a skew angle of the scan image from position information on the two images for skew detection. The image processing unit 600 generates a final scan image by compensating the scan image based on the calculated skew angle.

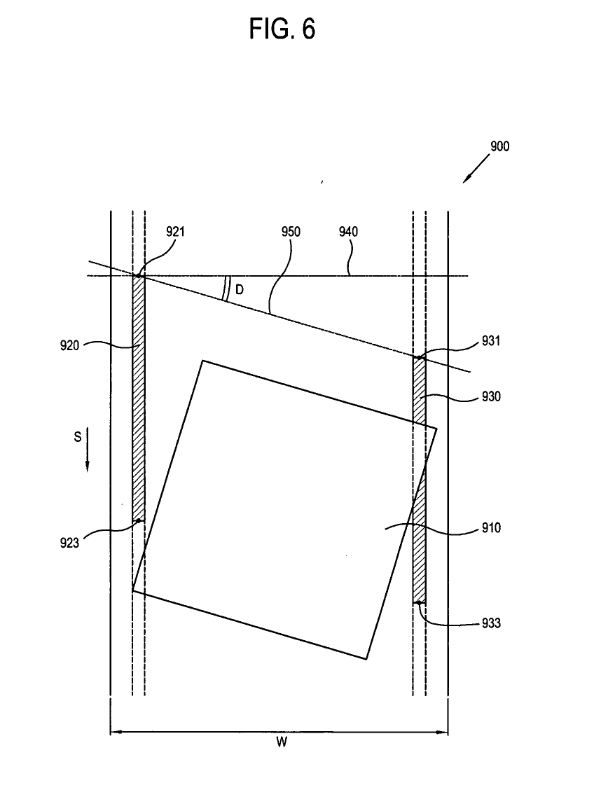

Hereinafter, an exemplary embodiment in which the image processing unit 600 calculates a skew angle from a primarily generated scan image will be described with reference to FIG. 6. FIG. 6 is an exemplary view of a scan image primarily scanned by the image reading unit 400.

As shown in FIG. 6, when horizontal pixel lines parallel to a scanning line 940 are sequentially delivered from the image reading unit 400 to the image processing unit 600, the image processing unit 600 generates a primary scan image 900 by sequentially placing the horizontal pixel lines in parallel along a line scanning direction S. The line scanning direction S means a scanning order of the manuscript, and a scanning line width W shown in FIG. 6 means a range in which the manuscript M is line-scanned by the image reading unit 400.

The scan image 900 contains a manuscript image 910, which is an effective image obtained by scanning the manuscript M, and a first detection image 920 and a second detection image 930, which are respectively formed by the rotation of the second end portion 815 of the first actuator 810 and the second end portion 825 of the second actuator 820. Images for other regions are images obtained by scanning the plate 700.

The first detection image 920 is formed in a range from its first leading end 921 to its first tailing end 923 along the line scanning direction S, as will be described in detail below.

The first leading end 921 corresponds to a position at which the first detection image 920 begins to be formed from the point of time when the second end portion 815 of the first actuator 810 opens the first opening 710 as the leading end of one side of the manuscript M interferes with the first end portion 813 of the first actuator 810. While the manuscript M is being transporting with the interference with the first end portion 813 of the first actuator 810, the first detection image 920 continues to be formed along the line scanning direction S. The first tailing end 923 corresponds to a position at which the formation of the first detection image 920 is completed at the point of time when the second end portion 815 of the first actuator 810 closes the first opening 710 as the manuscript M escapes from the first end portion 813 of the first actuator 810.

The second detection image 930 may be analyzed in a manner similar to the first detection image 920. That is, while the second end portion 825 of the second actuator 820 opens/closes the second opening 720, the second detection image 930 in the scan image 900 is formed to extend from its second leading end 931 to its second tailing end 933 along the line scanning direction S.

However, as shown in FIG. 6, the second leading end 931 is located behind the first leading end 921 along the line scanning direction S, rather than being located on the same scanning line 940 as the first leading end 921. This means that the point of time when the manuscript M interferes with the first end portion 813 of the first actuator 810 is different from the point of time when the manuscript M interferes with the first end portion 823 of the second actuator 820 and accordingly the manuscript M is scanned by the image reading unit 400 under a condition where the manuscript M is inclined at a certain angle with respect to the scanning line 940.

The image processing unit 600 calculates out the scanning line 940 passing the first leading end 921 and a leading end connecting line 950 connecting the first leading end 921 and the second leading end 931. Then, the image processing unit 600 calculates an angle between the scanning line 940 and the leading end connecting line 950 as a skew angle D.

The reason why the skew angle D can be calculated is that the image reading unit 400 scans the manuscript M in a sequential manner in parallel to the scanning line 940 and the first leading end 921 are formed at respective different points of time when the manuscript M interferes with the first end portion 813 of the first actuator 810 and the first end portion 823.

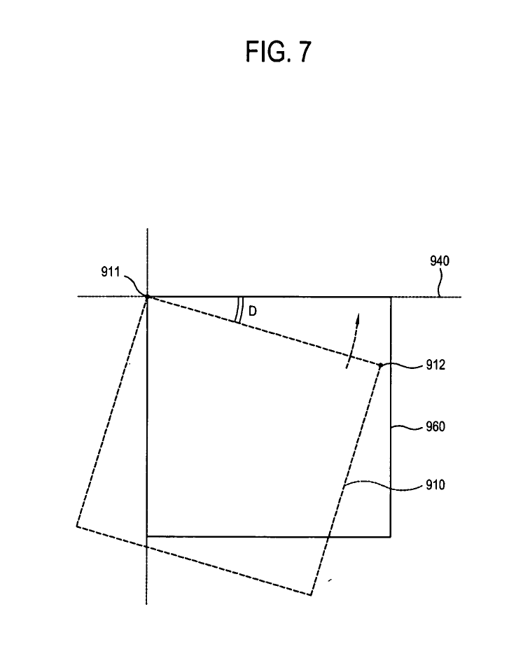

Hereinafter, an exemplary embodiment in which the image processing unit 600 compensates the scan image 900, particularly the manuscript image 910, which is obtained by scanning the manuscript M, in the scan image 900 based on the calculated skew angle D will be described with reference to FIG. 7. FIG. 7 is an exemplary view showing a method in which the image processing unit 600 compensates the scan image 900 based on the skew angle D.

As shown in FIG. 7, the image processing unit 600 calculates the skew angle D from the leading end connecting line 950 connecting the first leading end 921 and the second leading end 931. In addition, the processing unit 600 calculates out the scanning line 940 to include a first vertex 911.

The image processing unit 600 generates a compensated image 960 by rotating the scan image 900 or the manuscript image 910 by the skew angle D with the first vertex 911 as an axis. Here, the rotation direction of the manuscript image 910 refers to a direction in which a second vertex 912 approaches the scanning line 940.

As an alternative embodiment, the following method is possible. The image processing unit 600 calculates out the scanning line 940 passing the second vertex 912 and rotates the manuscript image 910 by the skew angle D with the second vertex 912 as an axis. Here, the rotation direction of the manuscript image 910 refers to a direction in which the first vertex 911 approaches the scanning line 940, which is reverse to the rotation direction in the previous embodiment.

The image processing unit 600 outputs the generated compensated image 960 to the printer 20 to form a visible image on a printing medium.

The spirit of the invention is not limited to the above-described embodiments but may be modified in design in various ways.

For example, the skew angle D may be calculated and applied after the manuscript M has been scanned or while the manuscript M is being scanned. In the latter, the skew angle D may be calculated at the point of time when the first leading end 921 and the second leading end 931 of the horizontal pixel lines delivered from the image reading unit 400 to the image processing unit 600 appear. The image processing unit 600 may perform an image compensating process in real time based on the skew angle D calculated while the manuscript M is being scanned.

In this manner, since the skew angle D may be initially calculated at the point of time when the manuscript M is scanned, it is advantageous that the first end portion 813 of the first actuator 810 and the first end portion 823 of the second actuator 820 are placed at an input stage of the manuscript M at the image reading position.

In this manner, according to this embodiment, it is possible to read the images 920 and 930 for skew detection formed as the first actuator 810 and the second actuator 820 are moved with the interference with the manuscript M being transported, from the scan image 900, calculate the skew angle D from the position information on the read images 920 and 930 for skew detection, and compensate the scan image 900 based on the calculated skew angle D.

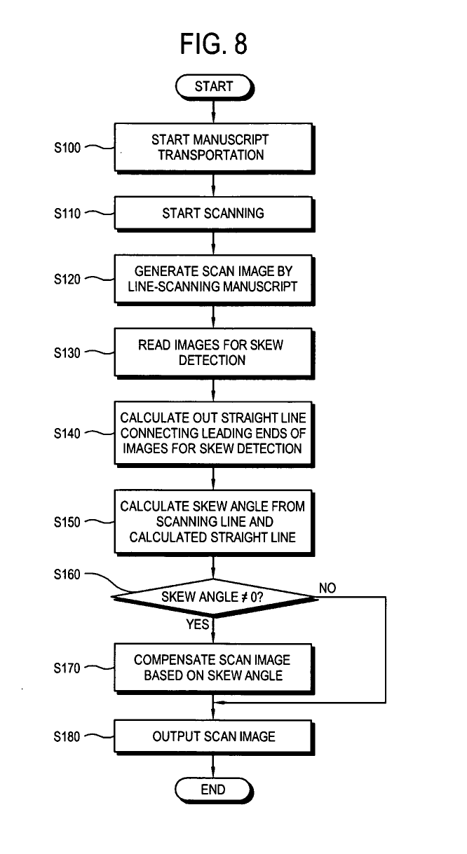

Hereinafter, a method of compensating the scan image in the image forming apparatus 1 according to this embodiment will be described with reference to FIG. 8. FIG. 8 is a control flow chart showing a process of compensating the scan image.

As shown in FIG. 8, the manuscript M to be scanned begins to be transported (S100). Then, the image reading unit 400 starts a scanning operation (S110).

The image reading unit 400 line-scans the manuscript M and the image processing unit 600 generates a scan image from the line-scanned manuscript M (S120). The image processing unit 600 reads images for skew detection from the scan image (S130) and calculates out a straight line connecting leading ends of the images for skew detection (S140).

The image processing unit 600 calculates a skew angle from a scanning line and the straight line (S150). The image processing unit 600 checks whether or not the calculated skew angle is 0 (S160).

If it is checked that the calculated skew angle is 0, the image processing unit 600 performs no separate compensation for the scan image. If it is checked that the calculated skew angle is not 0, the image processing unit 600 compensates the scan image based on the skew angle (S170). Then, the image processing unit 600 outputs the compensated scan image (S180).

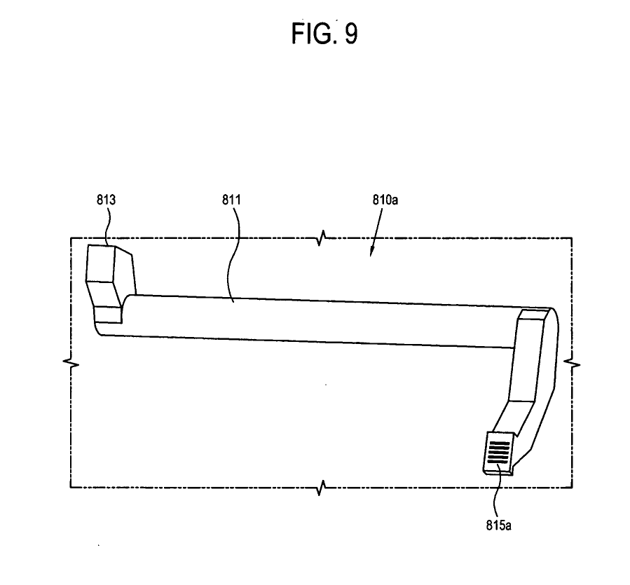

Although it has been illustrated in the above embodiment that one side of each of the second end portions 815 and 825 closing the openings 710 and 720 has the same white color as the plate 700, the spirit of the invention is not limited thereto but may have any colors. Hereinafter, a configuration of an actuator 810a according to another exemplary embodiment will be described with reference to FIG. 9.

As shown in FIG. 9, the actuator 810a includes a shaft 811, a first end portion 813 which is coupled to one end portion of the shaft 811 and interferes with the manuscript M, and a second end portion 815a which is coupled to the other end portion of the shaft 811 and closes or opens the openings 710 and 720.

In this embodiment, one side of the second end portion 815a closing the openings 710 and 720 is formed with a predetermined pattern. An image with such a pattern is formed in a scan image primarily formed by the scanning of the image reading unit 400 along the line scanning direction S.

The image processing unit 600 may read an image for skew detection based on the point of time of variation of the patterned image in the scan image. That is, the image corresponding to the first leading end 921 and the second leading end 931 in the previous embodiment has a reduced magnification of the patterned image in this embodiment.

With this configuration, in this embodiment, it is possible to more accurately detect the point of time when the openings 710 and 720 are opened, as compared to the previous embodiment.

Although a few exemplary embodiments have been shown and described, it will be appreciated by those skilled in the art that changes may be made in these embodiments without departing from the principles and spirit of the invention, the scope of which is defined in the appended claims and their equivalents.

What is claimed is:

1. A scanner comprising:
a transporting unit which transports a manuscript and passes the manuscript through a preset image reading position;
an image reading unit which outputs a scan image obtained by sequentially line-scanning the manuscript passing through the image reading position;
at least two actuators which are isolated from each other in a horizontal direction with respect to a manuscript transport direction, each having a first end portion which is movable with interference with the manuscript being transported and a second end portion which is placed on a scanning line scanned by the image reading unit and is movable in interlock with the first end portion; and
an image processing unit which reads images for skew detection which are formed in the scan image by the movement of the second end portions.

2. The scanner according to claim 1, wherein the image processing unit calculates a skew angle of the scan image from position information on the images for skew detection and compensates the scan image based on the calculated skew angle.

3. The scanner according to claim 2, wherein the image processing unit calculates an angle between a straight line connecting leading ends of the images for skew detection formed by the second end portions and the scanning line, as the skew angle.

4. The scanner according to claim 3, further comprising a plate which has a plurality of openings opened/closed by the second end portion and extends to face the image reading unit with a manuscript transport path interposed between the plate and the image reading unit.

5. The scanner according to claim 4, wherein the actuators are provided such that the second end portions closes the openings if the first end portions do not interfere with the manuscript and the second end portions open the openings when the first end portions are rotated with interference with the manuscript.

6. The scanner according to claim 5, wherein the first end portions are rotated around a shaft with the interference with the manuscript and the second end portions are rotated in interlock with the first end portions.

7. The scanner according to claim 5, wherein a predetermined pattern is formed on one side of the second end portion facing the image reading unit, and
wherein the image processing unit reads the images for skew detection based on a variation of the patterned image in the scan image.

8. The scanner according to claim 4, wherein the plate includes a transparent member formed in the openings.

9. The scanner according to claim 1, wherein the first end portions are formed at an input stage of the manuscript at the image reading position.

10. An image forming apparatus comprising:
a scanner which scans a manuscript; and
a printer which forms an image of the manuscript scanned by the scanner on a printing medium,
wherein the scanner includes
a transporting unit which transports the manuscript and passes the manuscript through a preset image reading position;
an image reading unit which outputs a scan image obtained by sequentially line-scanning the manuscript passing through the image reading position;
at least two actuators which are isolated from each other in a horizontal direction with respect to a manuscript transport direction, each having a first end portion which is movable with interference with the manuscript being transported and a second end portion which is placed on a scanning line scanned by the image reading unit and is movable in interlock with the first end portion; and
an image processing unit which reads images for skew detection which are formed in the scan image by the movement of the second end portions.

11. The image forming apparatus according to claim 10, wherein the image processing unit calculates a skew angle of the scan image from position information on the images for skew detection, compensates the scan image based on the calculated skew angle, and outputs the compensated scan image to the printer.

12. An image compensating method of a scanner including an image reading unit which scans a manuscript passing through a preset image reading position and at least two actuators which are isolated from each other in a horizontal direction with respect to a manuscript transport direction, each having a first end portion which is movable with interference with the manuscript being transported and a second end portion which is placed on a scanning line scanned by the image reading unit and is movable in interlock with the first end portion, the method comprising:
outputting a scan image obtained by sequentially line-scanning the manuscript passing through the image reading position; and
reading images for skew detection which are formed in the scan image by the movement of the second end portions.

13. The image compensating method according to claim 12, wherein the reading images for skew detection includes:
calculating a skew angle of the scan image from position information on the images for skew detection; and
compensating the scan image based on the calculated skew angle.

14. The image compensating method according to claim 13, wherein the calculating a skew angle of the scan image includes calculating an angle between a straight line connecting leading ends of the images for skew detection formed by the second end portions and the scanning line, as the skew angle.

15. The image compensating method according to claim 12, wherein a predetermined pattern is formed on one side of the second end portion facing the image reading unit, and
wherein the reading images for skew detection includes reading the images for skew detection based on a variation of the patterned image in the scan image.

16. The image compensating method according to claim 12, wherein the first end portions are formed at an input stage of the manuscript at the image reading position.

17. A method of outputting a compensated scan image in an image forming apparatus, the method comprising:
transporting a manuscript;
line-scanning the manuscript;
generating a scan image from the line-scanned manuscript;
reading images for skew detection from the scan image;
calculating a skew angle based on the images for skew detection; and
compensating selectively the scan image based on the skew angle, and outputting the compensated scan image.

18. The method according to claim 17, wherein the calculating a skew angle based on the images for skew detection comprises:
calculating out a straight line connecting leading ends of the images for skew detection; and
calculating the skew angle from a scanning line and the straight line.

19. The method according to claim 17, wherein the compensating selectively the scan image based on the skew angle comprises:
determining whether or not the calculated skew angle is 0;
performing no separate compensation for the scan image if the calculated skew angle is 0; and
compensating the scan image based on the skew angle if the calculated skew angle is not 0.
